(19) United States
(12) Patent Application Publication
(10) Pub. No.: US 2016/0121665 A1
(43) Pub. Date: May 5, 2016

(54) PNEUMATIC VEHICLE TIRE

(71) Applicant: Continental Reifen Deutschland GmbH, Hannover (DE)

(72) Inventor: Patrick Moldenhauer, Kiel (DE)

(21) Appl. No.: 14/993,776

(22) Filed: Jan. 12, 2016

Related U.S. Application Data
(63) Continuation of application No. PCT/EP2014/057225, filed on Apr. 10, 2014.

(30) Foreign Application Priority Data
Jul. 12, 2013 (DE) 10 2013 107 385.9

(51) Int. Cl. B60C 19/08; B60C 15/02; B60C 15/00

(52) U.S. Cl. CPC B60C 19/088; B60C 19/084; B60C 15/0009; B60C 15/02

(57) ABSTRACT

A pneumatic vehicle tire is configured for mounting on a rim. The tire includes a bead region having a bead core disposed therein and a side wall. A carcass insert extends around the bead region and has a turn-up extending in the direction of the side wall. A rim rubber forms an outer surface of the bead region and includes a first rim rubber part made of an electrically non-conductive rubber mixture and a second rim rubber part made of an electrically conductive rubber mixture. The second rim rubber part runs within the tire and forms an electrically conductive connection to the rim while the first rim rubber part extends beyond the rim flange and is in contact with the rim flange. The first rim rubber part is made of a rubber mixture having a low hysteresis.

### CROSS REFERENCE TO RELATED APPLICATIONS

This application is a continuation application of international patent application PCT/EP2014/057225, filed Apr. 10, 2014, designating the United States and claiming priority from German application 10 2013 107 385.9, filed Jul. 12, 2013, and the entire content of both applications is incorporated herein by reference.

### FIELD OF THE INVENTION

The invention relates to a radial pneumatic vehicle tire having at least one component made of at least one electrically non-conductive rubber mixture, including bead regions with bead cores, a carcass insert, which runs around the bead cores and has turn-ups, which extend in the direction of sidewalls, and a rim rubber, which forms the outer surface of the bead region, runs along the carcass turn-up and includes a rim rubber part made of an electrically non-conductive rubber mixture and a rim rubber part made of an electrically conductive rubber mixture, which connects to the rim at least one electrically conductive component that runs in the tire and forms or plays a part in forming an electrically conducting connection to the outer side of the tire.

### BACKGROUND OF THE INVENTION

Such a pneumatic vehicle tire is known from U.S. Pat. No. 8,887,776 which is incorporated herein by reference. The part of the rim rubber that consists of the electrically conductive rubber mixture runs as a cross-sectionally narrow strip along the carcass turn-up into the region radially beneath the bead core. The electrically non-conducting rim rubber part at least partially covers the electrically conductive rim rubber part on the outside and, in the direction of the tread, is overlapped by the sidewall. Between the carcass insert or the carcass turn-up and the sidewall or the rim rubber, incorporated in the tire is an electrically conductive rubber layer which is led to the outside in the region of the tread and which establishes the electrically conducting connection between the tread, which comes into contact with the roadway, and the rim. In the case of pneumatic vehicle tires of which the tread and sidewalls are made of electrically non-conductive rubber mixtures, in particular of rubber mixtures that contain a high proportion of silica, such an electrically conducting connection is necessary in order to prevent the vehicle from becoming electrostatically charged during driving. Silica-containing rubber mixtures, in particular in the tread, actually provide the tire with good driving properties, for example good wet-skidding properties, and contribute to reducing the rolling resistance.

### SUMMARY OF THE INVENTION

It is an object of the invention to provide a tire of the type mentioned above wherein a reliable electrically conductive connection is maintained in the bead regions by the rim rubber and at the same time the rolling resistance of the tire can be reduced.

The set object is achieved according to the invention by the electrically non-conducting rim rubber part extending in the direction of the sidewall beyond the rim flange and in contact with it and being made of a rubber mixture having a low hysteresis.

In the region of the rim, the pneumatic vehicle tire is subjected to particularly great loading, in particular flexural loading, during rolling. A rubber mixture of a low hysteresis produces less deformation-induced energy losses in the rim rubber part stressed by the rim flange than a rubber mixture of a high hysteresis and plays a part in reducing the rolling resistance.

In order to keep down the energy losses in the rim rubber part that is made of an electrically non-conducting rubber mixture and is stressed by the rim flange, it is advantageous if the electrically non-conductive rim rubber part has a rebound resilience at room temperature (according to DIN 53512) that is between 40% and 80%.

In the case of a preferred embodiment of the invention, the electrically conductive rim rubber part is formed as a solid part that plays a part in forming the bead toe and comes into contact with the bead-seating surface of the rim. A rim rubber part of such a configuration provides a particularly effective discharge of electrostatic charges. In the case of a further advantageous embodiment of the electrically conductive rim rubber part, it has a Shore A hardness of 60, in particular 65. This rim rubber part therefore has good mechanical strength, which is especially favorable for preventing damage to the bead regions during the fitting of the pneumatic vehicle tire.

In the case of another embodiment of the invention, the electrically conducting rim rubber part is formed by at least one rubber strip, which crosses through the electrically non-conducting rubber part, which otherwise takes up the remaining rim rubber, and forms an electrically conducting passage between the rim, in particular the rim flange, and the electrically conductive component in the tire. One or more such rubber strips may be installed at virtually any locations in the rim rubber part. At the same time, this rubber strip made of the electrically conducting rubber mixture may be configured as a component that runs annularly around the tire, but it may also be a narrow strip that is installed at a single location in the rim rubber. A configuration in which a number of such rubber strips are installed in the rim rubber at a number of locations distributed over the circumference is also possible.

The electrically conductive component that is connected to the rim by way of the electrically conducting rim rubber part may be the carcass rubberizing compound, which is made of an electrically conductive rubber mixture; this component may however also be formed by the carcass filaments of the carcass insert.

### BRIEF DESCRIPTION OF THE DRAWINGS

The invention will now be described with reference to the drawings wherein:

FIG. 1 shows a cross section through one of the bead regions of a pneumatic vehicle tire with one embodiment of the invention; and,

FIG. 2 shows a further configuration variant of the invention in a sectional representation analogous to FIG. 1.

### DESCRIPTION OF THE PREFERRED EMBODIMENTS OF THE INVENTION

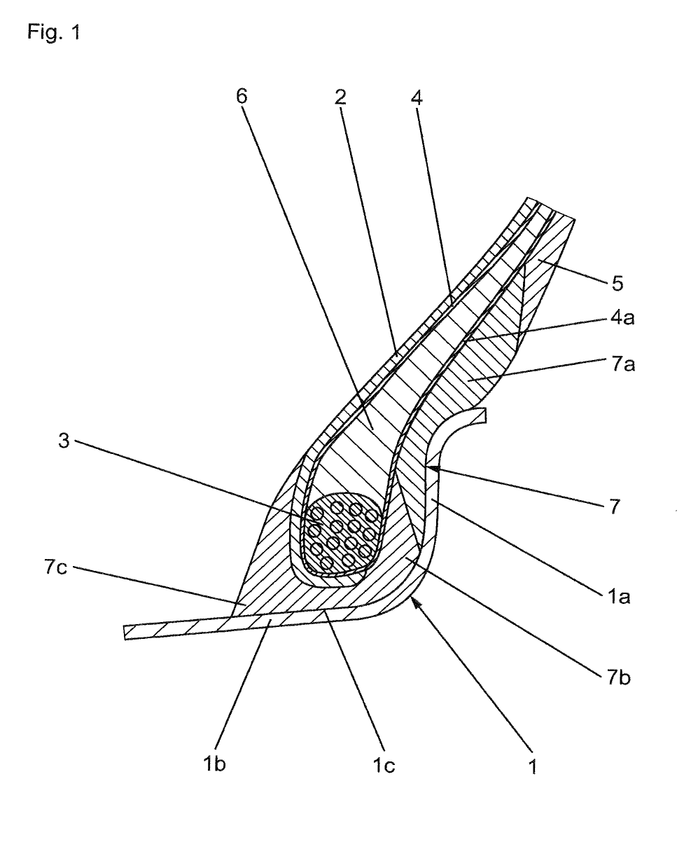

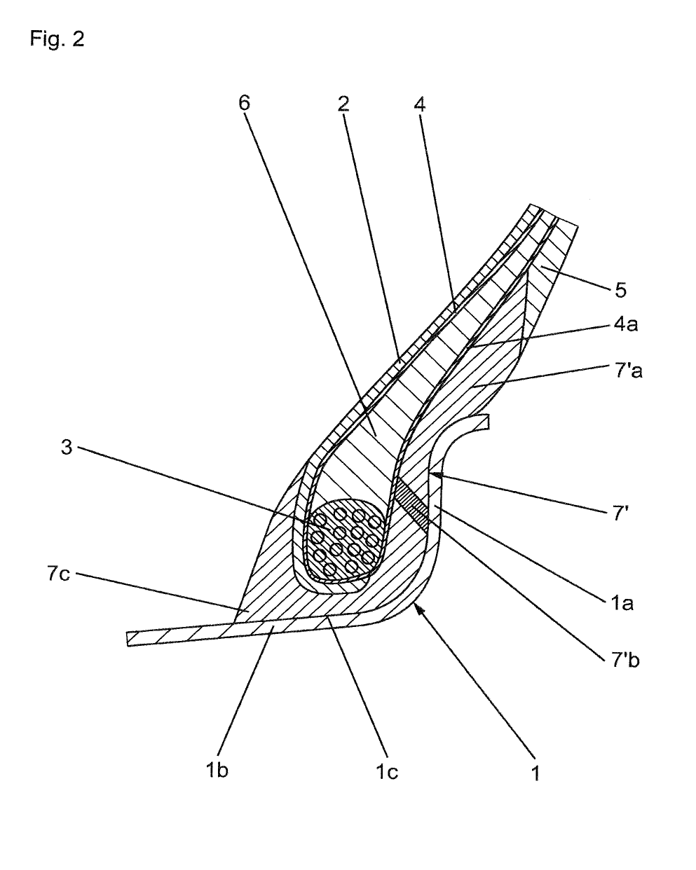

The figures respectively show one of the bead regions of a pneumatic vehicle tire for passenger cars, and therefore the inner layer 2, a bead core 3, the carcass insert 4, one of the sidewalls 5, a bead filler 6 and a rim rubber 7. The component parts of the pneumatic vehicle tire that are not shown and can be configured in a known and customary way include a profiled tread and a belt assembly, which is made up of a number of bracing plies. Also shown in FIGS. 1 and 2 is the part of a rim 1 that is in contact with the bead region of the tire in the case of a mounted tire. Shown therefore are the rim flange 1a and the bead portion 1b that defines the bead-seating surface 1c. The bead core 3 is made in a way known per se of steel cords; the bead filler 6, arranged radially outside the bead core 3 and seated on it, is made of a rubber mixture, particularly having a high modulus of elasticity, and may be of a one-part or multi-part configuration; in the case of a multi-part configuration, the bead filler 6 may be made of rubber mixtures of different moduli of elasticity. The carcass insert 4 particularly has textile reinforcing elements, in particular a woven fabric, which is embedded in a rubber mixture, the carcass rubberizing compound. The reinforcing elements run at least substantially in a radial direction in the carcass insert 4, and therefore at right angles to the circumferential direction of the tire. The carcass insert 4 extends from bead region to bead region, runs radially within the belt assembly, within the sidewalls 5 and, in the bead regions, from the inside to the outside around the bead cores 3 and in contact with them and also the bead filler 6. The portion running axially outside the bead filler 6, the turn-up 4a, respectively ends at the sidewall 5. The inner layer 2 runs on the inner side of the tire along the carcass insert 4 and ends in each bead region in the region of the turn-up of the carcass insert 4 around the bead core 3.

The rim rubber 7 is the part in the bead region of the pneumatic vehicle tire that comes into contact with the rim 1 in the case of a fitted tire. The rim rubber 7 consists substantially of a portion including the bead toe 7c and running outside the end portion of the inner layer 2, encloses the end portion of the inner layer 2 and extends along the turn-up 4a of the carcass insert 4 up to the sidewall 5. Here, the rim rubber 7 runs along the turn-up 4a beyond the rim flange 1a and radially outside the rim flange 1a with an approximately triangular end portion, the sidewall 5 covering over this end portion of the rim rubber 7 from the outside.

At least one tire component, preferably the tread (not shown) of the tire and/or the sidewalls 5, respectively consist(s) of at least one electrically non-conducting rubber mixture, in particular of a silica-filled rubber mixture, which provides the pneumatic vehicle tire with good driving properties, such as good wet-skidding properties, and also a lower rolling resistance. The inadequate electrical conductivity is mixture-dependent and a disadvantageous property, since electrostatic charging of the vehicle has to be avoided by special measures. For example, a so-called carbon center beam—a strip made of an electrically conductive rubber mixture—is therefore installed in the tread and establishes an electrically conductive connection between the outer side of the tread and an electrically conductive component in the substructure or the belt rubberizing compound, the carcass rubberizing compound or the electrically conducting carcass filaments. The discharge of electrostatic charges takes place by way of the electrically conductive component and a further electrically conductive rubber mixture, which establishes a connection with the rim 1. An electrically conductive rubber mixture is understood as meaning such a mixture that has an electrical resistivity of at most 10⁶ Ωcm. An electrically non-conducting rubber mixture is such a mixture in which the electrical resistivity is ≧10⁸ Ωcm. The electrical conductivity of a rubber mixture is achieved in particular by a corresponding proportion of carbon black in the basic rubber mixture or by adding graphite and the like.

In the case of the embodiment shown in FIG. 1, the rim rubber 7 is of a two-part configuration and includes a rim rubber part 7a and a rim rubber part 7b. An electrically conducting connection between the carcass filaments in the carcass insert 4 and the rim 1 takes place here by way of example by way of the rim rubber part 7b. The rim rubber part 7a is made of an electrically non-conducting rubber mixture and takes up the part of the rim rubber 7 that includes the end portion at the sidewall 5 and the portion that runs along the rim flange 1a and is in contact with it. In this case, the rim rubber part 7a particularly runs at least along one third of the radial extent of the rim flange 1a. The rim rubber part 7a overlaps from the outside the rim rubber part 7b, which takes up the remaining part of the rim rubber 7. The regions of the rim rubber parts (7a, 7b) that overlap one another are substantially triangles in cross section.

As mentioned, the rim rubber part 7a extends along the rim flange 1a and beyond the rim flange 1a of the rim 1. During the operation of the tire, the part 7a of the rim rubber 7 is exposed to appreciable deformations and therefore is made of a rubber mixture with a low hysteresis. A rubber mixture with a low hysteresis is to be understood as meaning such a mixture of which the rebound resilience at room temperature (according to DIN 53512) is at least 40% and in particular up to 80%. In the case of a rubber mixture, a low hysteresis is achieved in a known way by the use of suitable crude rubbers, by fillers and proportions thereof and the like. The rubber mixture for the rim rubber part 7b is optimized with regard to a high electrical conductivity; its hysteresis is not important.

In the case of the embodiment shown in FIG. 2, an electrically non-conducting rim rubber part 7′a, which takes up virtually the entire rim rubber 7′, is provided. The electrically conductive rim rubber part 7′b is formed by at least one rubber strip 7′b, which crosses through the electrically non-conducting rim rubber part 7′a and forms an electrically conductive passage between the rim flange 1a and the turn-up 4a of the carcass insert 4 or the carcass filaments thereof. The rubber strip 7′b may be installed locally at one location as a narrow strip. A number of rubber strips 7′b may be installed over the circumference of the tire, forming a number of electrically conducting passages. The rubber strip may also be configured as an annular component and be installed so as to run over the entire circumference of the tire. The rubber strip 7′b has a cross-sectional thickness of 0.5 mm to 2.5 mm and is made of a rubber mixture that is optimized with regard to electrical conductivity. The rim rubber part 7′a is made of a rubber mixture that is optimized with regard to a low hysteresis, as already described with reference to the rim rubber part 7a.

In the case of the embodiment according to FIG. 1, it is also advantageous if the rubber mixture of the rim rubber part 7b is not only electrically conductive but also has a high Shore A hardness of 60, in particular 65 (according to DIN 53505). This measure provides the rim rubber part 7b with greater mechanical robustness and is favorable for avoiding damage to the bead regions during the fitting of the pneumatic vehicle tire.

In the case of a further possible embodiment, a separate, electrically conductive rubber layer, which runs between the electrically conductive part of the rim rubber and the region of the tread, may be inserted in the tire.

It is understood that the foregoing description is that of the preferred embodiments of the invention and that various changes and modifications may be made thereto without departing from the spirit and scope of the invention as defined in the appended claims.

### LIST OF DESIGNATIONS

### Part of the Description

1 . . . rim
1a . . . rim flange
1b . . . portion
1c . . . bead-seating surface
2 . . . inner layer
3 . . . bead core
4 . . . carcass insert
4a . . . turn-up
5 . . . sidewall
6 . . . bead filler
7 . . . rim rubber
7′ . . . rim rubber
7a, 7b . . . rim rubber part
7′a, 7′b . . . rim rubber part
7c . . . bead toe

What is claimed is:

1. A pneumatic vehicle tire having a radial configuration and configured to be mounted on a rim having a rim flange, the pneumatic vehicle tire comprising:
a bead region having a bead core disposed therein;
a side wall;
a carcass insert extending around said bead region and having a turn-up extending in the direction of said side wall;
said bead region having an outer surface;
a rim rubber forming said outer surface of said bead region;
said rim rubber including a first rim rubber part made of an electrically non-conductive rubber mixture and a second rim rubber part made of an electrically conductive rubber mixture;
said second rim rubber part defining an electrically conductive component running within the tire and forming an electrically conductive connection to the rim;
said first rim rubber part extending in the direction of said side wall beyond the rim flange and being in contact with the rim flange; and,
said first rim rubber part being made of a rubber mixture having a low hysteresis.

2. The pneumatic vehicle tire of claim 1, wherein said rubber mixture of said first rim rubber part has a rebound resilience lying in a range of 40% to 80% at room temperature (according to DIN 53512).

3. The pneumatic vehicle tire of claim 1, wherein said second rim rubber part forms a bead toe having a bead seating surface;
and, said second rim rubber part contacts the rim via said bead seating surface.

4. The pneumatic vehicle tire of claim 1, wherein said rubber mixture of said second rim rubber part has a Shore hardness of 60.

5. The pneumatic vehicle tire of claim 1, wherein said rubber mixture of said second rim rubber part has a Shore hardness of 65.

6. The pneumatic vehicle tire of claim 1, wherein said second rim rubber part is a rubber strip which crosses through said first rim rubber part, which otherwise takes up the entirety of said rim rubber, and forms an electrically conductive passage between the rim and an electrically conductive component disposed in the tire.

7. The pneumatic vehicle tire of claim 6, wherein said second rim rubber part forms an electrically conductive passage between the rim flange and said component.

7. The pneumatic vehicle tire of claim 1, wherein said electrically conductive component is a carcass rubberizing compound.

8. The pneumatic vehicle tire of claim 1, wherein:
said carcass insert includes carcass filaments; and,
said electrically conductive component is formed by said carcass filaments.
